(19) United States
(12) Patent Application Publication
(10) Pub. No.: US 2021/0222268 A1
(43) Pub. Date: Jul. 22, 2021

(54) METHOD AND SYSTEM FOR TREATING MOLYBDENUM-CONTAINING SEWAGE IN MOLYBDENUM ORE AREA

(71) Applicant: Liaoning Beifang Environmental Protection Co., Ltd., Shenyang (CN)

(72) Inventors: Zhuo WANG, Shenyang (CN); Yu WANG, Shenyang (CN); Yinping LI, Shenyang (CN); Chuanpeng YU, Shenyang (CN); Weiwu LIU, Shenyang (CN)

(21) Appl. No.: 17/214,557

(22) Filed: Mar. 26, 2021

(30) Foreign Application Priority Data
Mar. 26, 2020 (CN) 202010221747.5

(51) Int. Cl. C22B 3/22; C22B 3/44; C22B 34/34

(52) U.S. Cl. CPC C22B 3/22; C22B 34/34; C22B 3/44

(57) ABSTRACT

The disclosure relates to sewage treatment, and more particularly to a method and a system for treating molybdenum-containing sewage in molybdenum ore area. In the method, the molybdenum-containing sewage is preliminarily treated in the preliminary precipitation tank to allow the impurities to settle, and then the supernatant sequentially flows into the reaction system and the filtration system for filtration. The effluent discharged from the filtration system has a molybdenum content less than 1.5 mg/L.

### CROSS-REFERENCE TO RELATED APPLICATIONS

This application claims the benefit of priority from Chinese Patent Application No. 202010221747.5, filed on Mar. 26, 2020. The content of the aforementioned application, including any intervening amendments thereto, is incorporated herein by reference in its entirety.

### TECHNICAL FIELD

This application relates to sewage treatment, and more particularly to a method and a system for treating molybdenum-containing sewage in a molybdenum ore area.

### BACKGROUND

Recently, the rapid development of economy in China has brought an increasing demand for ore resources such as metal ores and non-metallic ores, which promotes the rapid development of ore mining and dressing industry. However, the heavy metals lost in the mining process will seriously harm the ecological environment. After entering the food chain, the toxic elements and heavy metals will pose potential threats to humans. Therefore, there is an urgent need to adopt effective measures to mitigate the mine sewage pollution, protect water resources and improve the living environment of the mining area.

As a rare heavy metal, the molybdenum is also an essential trace element for humans, animals and plants. However, excessive molybdenum is extremely harmful to human health. Specifically, it may cause in-vivo energy metabolism disorder, focal necrosis induced by myocardial anoxia, the occurrence of nephrolithiasis and lithangiuria and increased incidence of iron deficiency anemia, and induce dental caries. Molybdenum is the culprit of esophageal cancer, and can also cause gout syndromes, arthralgia and deformity, kidney damage, growth and development retardation, weight loss, hair loss, arteriosclerosis, connective tissue degeneration, skin diseases and other health problems.

More and more attention has been paid to the treatment of molybdenum pollution. Currently, the methods for removing molybdenum mainly include constructed wetland method, chemical precipitation method, ion exchange method and adsorption method. The adsorption method and the constructed wetland method can effectively enrich molybdate, but it is difficult to treat the subsequent molybdenum-containing waste, which may cause the molybdenum pollution transfer. Additionally, these two methods also have a low resource utilization, and the operation of constructed wetlands in cold areas is greatly limited by temperature and dissolved oxygen.

The ion exchange method can effectively reduce the content of molybdenum, but the treatment effect is greatly affected by pH and turbidity. Therefore, the sewage needs to be pre-treated to have a suitable pH value and turbidity. In addition, the ion exchange method further has large energy consumption and high operating cost. The chemical precipitation method has low requirements for water quality, so that it can be applied to treat those water bodies with high turbidity, having a wide application range and a brilliant application prospect. However, the water body needs to be adjusted to have a strong acidity before the treatment. In summary, the chemical precipitation method is considered suitable for treating heavy metal molybdenum-containing sewage. The chemical precipitation method has a relatively stable treatment effect for heavy metal sewage, but there are still many factors affecting the treatment effect. The traditional precipitation method requires harsh pH conditions and special flocculants, so that it can only be used in the industrial field. Moreover, it is required to additionally perform anti-corrosion treatment on the related equipment and pipelines considering the strong acidity of the low-pH sewage, which not only increases the cost and the construction complexity, but also raises higher requirement for the operation and maintenance. In addition, the selection of flocculant in the chemical precipitation method will also affect the removal effect and operating cost. At present, the single flocculant has the defects of large consumption, loose flocculation and high operation cost in actual use, which restricts its application.

### SUMMARY

In view of the above-mentioned technical problems, this application provides a method and a system for treating molybdenum-containing sewage in a molybdenum ore area. The method provided herein is based on multi-stage coagulation and precipitation, and has advantages of low acidity, short reaction time, low treatment cost, simple equipment and desirable effect.

The technical solutions of this application are described as follows.

In a first aspect, this application provides a method for treating molybdenum-containing sewage in a molybdenum ore area, comprising:

(1) subjecting the molybdenum-containing sewage into a primary precipitation tank followed by standing for 40-60 min to settle impurities in the molybdenum-containing sewage; allowing the impurities to flow into a pipeline of a sludge drying system, and allowing a supernatant in the primary precipitation tank to overflow into a regulating tank;

(2) pumping a liquid in the regulating tank to a reaction precipitation tank of a reaction system through a booster water pump, and adjusting pH of the liquid in the reaction precipitation tank to 4.5-5; adding a composite coagulant into the reaction precipitation tank, wherein the composite coagulant comprises polymeric ferric sulfate and ferrous sulfate; controlling a mass concentration of the composite coagulant in the reaction precipitation tank to be 70-150 mg/L; allowing molybdate ions in the liquid in the reaction precipitation tank to attract the composite coagulant to form a precipitate, and allowing the precipitate to flow into the pipeline of the sludge drying system; allowing a supernatant in the reaction precipitation tank to overflow into a two-box reaction tank; adding caustic soda into the two-box reaction tank to adjust pH of an effluent of the two-box reaction tank to 7.5, and allowing a supernatant in the two-box reaction tank to enter a filtration system for filtration; and

(3) subjecting the liquid entering the filtration system to filtration to remove impurities such that a molybdenum content in an effluent of the filtration system is less than or equal to 1.5 mg/L.

In some embodiments, when a molybdenum content in the molybdenum-containing sewage is less than or equal to 15 mg/L, the reaction system comprises a primary reaction system and the two-box reaction tank connected with each other; the primary reaction system comprises the reaction precipitation tank; the molybdenum-containing sewage sequentially flows into the primary precipitation tank, the reaction precipitation tank and the two-box reaction tank to enter the filtration system; the composite coagulant is added into the reaction precipitation tank, and the mass concentration of the composite coagulant in the reaction precipitation tank is controlled to be 70-150 mg/L; hydrochloric acid or sulfuric acid is added into the reaction precipitation tank to adjust pH to 4.5-5; the two-box reaction tank comprises an upper tank body and a lower tank body connected with each other; the caustic soda is added into the upper tank body, and a pH meter is arranged in the lower tank body to measure a pH value in the lower tank body; an amount of caustic soda added into the upper tank body is controlled according to the pH value in the lower tank body; and pH in the two-box reaction tank is adjusted to 7-7.5 to make a molybdenum content in the effluent of the two-box reaction tank less than or equal to 1.5 mg/L.

In some embodiments, when a molybdenum content in the molybdenum-containing sewage is greater than 15 mg/L and less than 30 mg/L, the reaction system includes a primary reaction system, a secondary reaction system and the two-box reaction tank sequentially connected in series; the primary reaction system comprises a primary reaction precipitation tank, and the secondary reaction system comprises a secondary reaction precipitation tank; the reaction precipitation tank consists of the primary reaction precipitation tank and the secondary reaction precipitation tank; the molybdenum-containing sewage sequentially flows into the primary precipitation tank, the primary reaction precipitation tank, the secondary reaction precipitation tank and the two-box reaction tank to enter the filtration system; the composite coagulant is added into the primary reaction precipitation tank, and a mass concentration of the composite coagulant in the primary reaction precipitation tank is controlled to be 70-150 mg/L; hydrochloric acid or sulfuric acid is added into the primary reaction precipitation tank to adjust pH to 4.5-5; caustic soda is added into the secondary reaction precipitation tank to adjust pH to 4.5-5; the composite coagulant is added into the secondary reaction precipitation tank, and a mass concentration of the composite coagulant in the secondary reaction precipitation tank is controlled to be 30-50 mg/L; the two-box reaction tank comprises an upper tank body and a lower tank body connected with each other; caustic soda is added into the upper tank body, and a pH meter is arranged in the lower tank body to measure a pH value in the lower tank body; an amount of caustic soda added into the upper tank body is controlled according to the pH value in the lower tank body; and pH in the two-box reaction tank is controlled to 7-7.5 to make a molybdenum content in the effluent of the two-box reaction tank less than or equal to 1.5 mg/L.

In a second aspect, this application also provides a treatment system used in the above method, comprising:

the primary precipitation tank;

the reaction system;

the filtration system; and

the sludge drying system;

wherein the primary precipitation tank, the reaction system and the filtration system are connected in series, and bottoms of the primary precipitation tank and the reaction system are both connected to the sludge drying system; and the molybdenum-containing sewage sequentially flows into the primary precipitation tank, the reaction system and the filtration system to be discharged.

In some embodiments, when a molybdenum content in the molybdenum-containing sewage is less than or equal to 15 mg/L, the reaction system comprises a primary reaction system and the two-box reaction tank connected with each other; the primary reaction system comprises a reaction precipitation tank, a first pH meter, a composite coagulant feeding device and an acid feeding device; the first pH meter is arranged on the reaction precipitation tank to measure a pH value in the reaction precipitation tank; the composite coagulant feeding device and the acid feeding device are connected to the reaction precipitation tank, and a bottom of the reaction precipitation tank is connected to a pipeline of the sludge drying system; the two-box reaction tank comprises an upper tank body and a lower tank body connected with each other; the upper tank body is connected to a caustic soda feeding device, and a second pH meter is arranged in the lower tank body to measure a pH value in the lower tank body; and the two-box reaction tank is connected to the filtration system.

In some embodiments, when a molybdenum content in the molybdenum-containing sewage is greater than 15 mg/L and less than 30 mg/L, the reaction system comprises a primary reaction system, a secondary reaction system and the two-box reaction tank sequentially connected in series; the primary reaction system comprises a primary reaction precipitation tank, a first pH meter, a first composite coagulant feeding device and an acid feeding device; the first pH meter is arranged on the primary reaction precipitation tank to measure a pH value in the primary reaction precipitation tank; the first composite coagulant feeding device and the acid feeding device are connected to the primary reaction precipitation tank; the secondary reaction system comprises a secondary reaction precipitation tank, a second pH meter, a second composite coagulant feeding device and a first caustic soda feeding device; the reaction precipitation tank consists of the first reaction precipitation tank and the secondary reaction precipitation tank; the second pH meter is arranged on the secondary reaction precipitation tank to measure a pH value in the secondary reaction precipitation tank; the second composite coagulant feeding device and the first caustic soda feeding device are connected to the secondary reaction precipitation tank; bottoms of the primary reaction precipitation tank and the secondary reaction precipitation tank are connected to a pipeline of the sludge drying system; the two-box reaction tank comprises an upper tank body and a lower tank body connected with each other; the upper tank body is connected to a second caustic soda feeding device, and a third pH meter is arranged in the lower tank body to measure a pH value in the lower tank body; and the two-box reaction tank is connected to the filtration system.

In some embodiments, the filtration system is a quartz sand filter; a water inlet end of the quartz sand filter is connected to the two-box reaction tank, and a water outlet end of the quartz sand filter is connected to a water collection tank; and bottoms of the quartz sand filter and the water collection tank are connected to a backwash valve.

In some embodiments, the sludge drying system comprises a sludge tank, a screw pump, a sludge reaction tank, a sludge feeding device and a stacked-screw component; an inlet of the sludge tank is connected to the primary precipitation tank and the reaction precipitation tank of the reaction system through the pipeline of the sludge drying system; an outlet of the sludge tank is connected to the screw pump, and the screw pump is connected to the sludge reaction tank through a pipeline; the sludge feeding device is communicated with the sludge reaction tank, and the sludge reaction tank contains polyacrylamide; and the sludge reaction tank is connected to the stacked-screw component; and the stacked-screw component is configured to discharge dry sludge in the sludge reaction tank.

In some embodiments, the primary precipitation tank and the reaction precipitation tank are connected to the pipeline of the sludge drying system through a sludge-discharging pipeline, respectively; and sludge-discharging pipelines of the primary precipitation tank and the reaction precipitation tank are provided with a sludge pump.

In some embodiments, water outlet pipes of the regulating tank and the two-box reaction tank are provided with the booster water pump, respectively.

This application has the following beneficial effects.

(1) The method provided herein for treating molybdenum-containing sewage adopts a multi-stage coagulation-precipitation process under weakly acidic conditions. Through adjusting the reaction pH and the addition amount of the flocculant, the molybdate ions in the molybdenum-containing sewage is allowed to react with the coagulant to form a precipitate, which is then transported to the sludge drying system to be discharged. By contrast, this method has advantages of low acidity, short reaction time, low treatment cost, simple equipment and good treating effect.

2. Through the combination of a primary precipitation tank, a reaction system, a filtration system and a sludge drying system, the treatment system provided herein enables the multi-stage coagulation and precipitation, and the discharged water and dry sludge meet the related standards. Moreover, the system has simple structure and desirable treatment effect.

### BRIEF DESCRIPTION OF THE DRAWINGS

The FIGURE is a schematic diagram of a structure of a system for treating molybdenum-containing sewage according to an embodiment of the present disclosure.

In the drawing, 1, primary precipitation tank; 2, adjusting tank; 3, primary reaction precipitation tank; 4, secondary reaction precipitation tank; 5, two-box reaction tank; 6, filtration system; 7, water collection tank; 8, sludge tank; 9-1, first composite coagulant feeding device; 9-2, second composite coagulant feeding device; 10, acid feeding device; 11-1, first caustic soda feeding device; 12, booster water pump; 13, backwash valve; 14, sludge pump; 15, screw pump; 16, sludge feeding device; 17, stacked-screw component; 18, sludge reaction tank; 19, pipeline of sludge drying system; 20, reaction system; 21, primary reaction system; 22, secondary reaction system; 23, reaction precipitation tank; 24, upper tank body; 25, lower tank body; 26, sludge drying system; 27-1, first pH meter; 27-2, second pH meter; and 27-3, third pH meter.

### DETAILED DESCRIPTION OF EMBODIMENTS

The disclosure will be further described below in detail with reference to the accompanying drawings and the embodiments.

### Embodiment 1

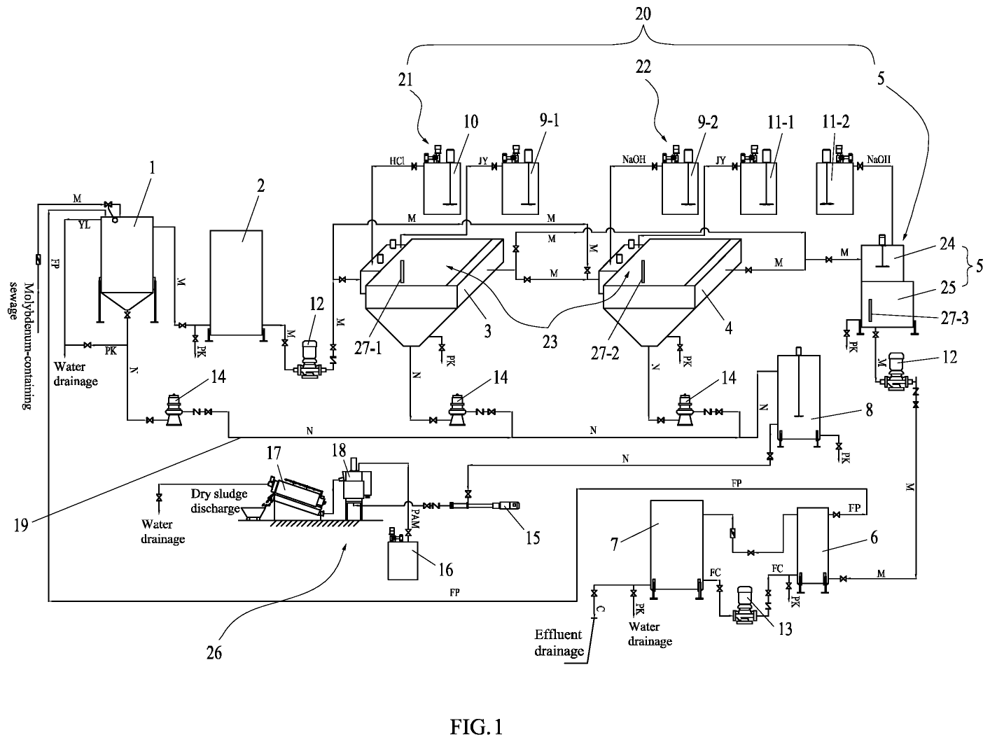

As shown in FIG. 1, a method for treating molybdenum-containing sewage in a molybdenum ore area is provided herein, which is specifically described as follows.

(1) Primary Precipitation

The molybdenum-containing sewage was fed into a primary precipitation tank 1 and subjected to standing for 40-60 min to allow impurities in the molybdenum-containing sewage to settle. The impurities in the primary precipitation tank 1 flowed into a pipeline 19 of a sludge drying system 26, and the supernatant overflows into a regulating tank 2.

(2) Secondary Precipitation

The supernatant in the regulating tank 2 is pumped to a reaction precipitation tank 23 of the reaction system 20 through a booster water pump 12, and pH in the reaction precipitation tank 23 is adjusted to 4.5-5. A composite coagulant consisting of polymeric ferric sulfate (PFS) and ferrous sulfate (FeSO₄) is added into the reaction precipitation tank 23, and a mass concentration of the composite coagulant in the reaction precipitation tank 23 was controlled to be 70-150 mg/L. The composite coagulant attracts the molybdate ions in the supernatant to form a precipitate, which then flows into the pipeline 19 of the sludge drying system 26. The supernatant in the reaction precipitation tank 23 then overflows into a two-box reaction tank 5, to which caustic soda is added to adjust pH of an effluent of the two-box reaction tank to 7.5. The supernatant in the two-box reaction tank 5 then flows into a filtration system 6 for filtration.

The ferrous ions released from the ferrous sulfate have a reducing effect in weakly acidic environment, which can reduce the valence state of molybdenum ions in the molybdenum-containing sewage through conversion to trivalent ions and change the existence form of molybdenum ions, so that they are prone to be adsorbed and precipitated.

The ferric ions released from the polymeric ferric sulfate in the sewage and the ferric ions generated from the reaction of ferrous sulfate with the molybdenum ions can play a role in promoting the coagulation and precipitation of molybdate ions. was a kind of As a high molecular polymer, the polymeric ferric sulfate can be hydrolyzed to produce a polynuclear complex, which has the functions of electron neutralization, compression of electric double layer, adsorption bridging and net trapping and precipitation in the sewage treatment.

(3) Filtration

The supernatant is filtered by the filtration system 6 to remove impurities such that a molybdenum content in an effluent of the filtration system 6 is less than or equal to 1.5 mg/L.

In an embodiment, a weight ratio of polymeric ferric sulfate (PFS) to ferrous sulfate (FeSO₄) in the composite coagulant was 4:1.

Molybdenum removal effect of PFS An initial mass concentration of molybdenum in the sample is 18 mg/L, and the molybdenum-removing effect under different dosages of PFS (with a gradient of 50 mg/L) is studied. The results are shown in Table 1.

TABLE 1
Molybdenum-removing effect under different dosages of PFS

| | Dosage of PFS | 50 | 100 | 150 | 200 | 250 | 300 |
|---|---|---|---|---|---|---|---|
| 1 | Molybdate content | 6.945 | 2.620 | 1.160 | 0.670 | 0.921 | 0.253 |
| | (mg/L) | | | | | | |
| 2 | Molybdate content | 6.829 | 1.152 | 0.993 | 0.980 | 0.836 | 0.415 |
| | (mg/L) | | | | | | |

Molybdenum Removal Effect of PFS/FeSO₄ The ratio of PFS to FeSO₄ is changed under the condition that the total dosage is always kept at 150 mg/L, and the removal effect of molybdenum is studied under the above-mentioned conditions.

The results are shown in Table 2, from which it can be concluded that the composite coagulant with a PFS/FeSO₄ weight ratio of 4:1 has the optimal molybdenum-removing effect.

TABLE 2
Removal effect of molybdenum under different mass ratio of
PFS to FeSO₄

| | | | | | | |
|---|---|---|---|---|---|---|
| Weight ratio of | 5:1 | 4:1 | 3:1 | 3:2 | 1:1 | 1:2 |
| PFS to FeSO₄ | | | | | | |
| Molybdate content | 1.009 | 0.853 | 1.073 | 1.574 | 1.893 | 2.624 |
| (mg/L) | | | | | | |

In an embodiment, in step (2), the pH in the reaction precipitation tank 23 of the reaction system 20 is adjusted to 4.5.

Effect of pH on Molybdenum Removal

On the premise that the total dosage of the composite coagulant is 150 mg/L, pH is used as a variable to evaluate the molybdenum-removing effect under the above-mentioned conditions. The results are shown in Table 3, from which it can be observed that the optimal molybdenum-removing effect is obtained at pH 4.5, and the removal rate exceeds 80%. By contrast, the removal rate of molybdenum is reduced to about 60% when pH is less than 3.5 or large than 5.0.

TABLE 3
Influence of pH on the molybdenum removal effect of iron
salt-based coagulation-precipitation method

| pH | 3 | 3.5 | 4 | 4.5 | 5 | 5.5 |
|---|---|---|---|---|---|---|
| Molybdate | 5.899 | 3.281 | 2.870 | 2.617 | 3.307 | 6.739 |
| content (mg/L) | | | | | | |
| Molybdenum | 67.23% | 81.77% | 84.06% | 85.46% | 81.63% | 62.56% |
| removal rate | | | | | | |

A system used in the above treatment process of the molybdenum-containing sewage includes the primary precipitation tank 1, the reaction system 20, the filtration system 6 and the sludge drying system 26. The primary precipitation tank 1, the reaction system 20 and the filtration system 6 are connected in series, and bottoms of the primary precipitation tank 1 and the reaction system 20 are both connected to the sludge drying system 26. The molybdenum-containing sewage sequentially flows into the primary precipitation tank 1, the reaction system 20 and the filtration system 6 to be discharged.

When a molybdenum content in the molybdenum-containing sewage is less than or equal to 15 mg/L, the reaction system 20 includes a primary reaction system 21 and the two-box reaction tank 5 connected with each other. The primary reaction system 21 includes a primary reaction precipitation tank 3. The reaction precipitation tank 23 includes the primary reaction precipitation tank 3. The reaction system 20 includes the primary reaction system 21 and the two-box reaction tank 5. The molybdenum-containing sewage sequentially flows into the primary precipitation tank 1, the primary reaction precipitation tank 3 and the two-box reaction tank 5 to enter the filtration system 6. The composite coagulant is added into the primary reaction precipitation tank 3, and the mass concentration of the composite coagulant in the primary reaction precipitation tank 3 was controlled to be 70-150 mg/L. Hydrochloric acid or sulfuric acid is added into the primary reaction precipitation tank 3 to adjust pH to 4.5-5. The two-box reaction tank 5 includes an upper tank body 24 and a lower tank body 25 connected with each other. Caustic soda was added into the upper tank body 24, and a third pH meter 27-3 is arranged in the lower tank body 25 to measure a pH value in the lower tank body 25. The amount of caustic soda added in the upper tank body 24 is controlled according to the pH value in the lower tank body 25. The pH in the two-box reaction tank 5 is controlled to 7-7.5 to make the molybdenum content in the effluent of the two-box reaction tank 5 less than or equal to 1.5 mg/L.

The primary reaction system 21 includes the primary reaction precipitation tank 3, a first pH meter 27-1, a first composite coagulant feeding device 9-1 and an acid feeding device 10. The first pH meter 27-1 is arranged on the primary reaction precipitation tank 3, and is configured to measure the pH value in the primary reaction precipitation tank 3. The first composite coagulant feeding device 9-1 and the acid feeding device 10 are both connected to the primary reaction precipitation tank 3. The composite coagulant is fed to the primary reaction precipitation tank 3 of the primary reaction system 21 through the first composite coagulant feeding device 9-1 to a mass concentration of 70-150 mg/L. Hydrochloric acid or sulfuric acid is added to the primary reaction precipitation tank 3 of the primary reaction system 21 through the acid feeding device 10 to adjust the pH value in the primary reaction precipitation tank 3 to 4.5-5. The bottom of the primary reaction precipitation tank 3 is connected to the pipeline 19 of the sludge drying system 26. The upper tank body 24 of the two-box reaction tank 5 is connected to the first caustic soda feeding device 11-1, and the lower tank body 25 of the two-box reaction tank 5 is provided with the third pH meter 27-3, which is configured to measure the pH value in the lower tank body 25 of the two-box reaction tank 5. The addition amount of caustic soda is controlled according to the pH value in the lower tank body 25. The pH value in the two-box reaction tank 5 is adjusted to 7-7.5. The two-box reaction tank 5 is connected to the filtration system 6. Specifically, the impurities generated in the primary reaction precipitation tank 3 flow into the pipeline 19 of the sludge drying system 26, and the supernatant in the primary reaction precipitation tank 3 flows into the two-box reaction tank 5 for reaction, and then enters the filtration system 6 for filtration. The filtration system 6 is a quartz sand filter. A water inlet end of the quartz sand filter is connected to the two-box reaction tank 5, and a water outlet end of the quartz sand filter is connected to a water collection tank 7. The bottoms of the quartz sand filter and the water collection tank 7 are connected to a backwash valve 13. Specifically, the supernatant flowing out of the quartz sand filter flows into the water collection tank 7. The quartz sand filter and the water tank 7 can be washed by the backwash valve 13.

The sludge drying system 26 included a sludge tank 8, a screw pump 15, a sludge reaction tank 18, a sludge feeding device 16 and a stacked-screw component 17. An inlet of the sludge tank 8 was connected to the primary precipitation tank 1 and the reaction precipitation tank 23 of the reaction system 20, through the pipeline of the sludge drying system 19. An outlet of the sludge tank 8 was connected with the screw pump 15, and the screw pump 15 was connected to the sludge reaction tank 18 through a pipeline. The sludge feeding device 16 was communicated to the sludge reaction tank 18. Polyacrylamide (PAM) was put into sludge reaction tank 18 through sludge feeding device 16. An outlet of the sludge reaction tank 18 was connected to the stacked-screw component 17; and the stacked-screw component 17 was configured to discharge dry sludge in the sludge reaction tank 18. Specifically, the screw pump 15 was configured to transfer the sludge (impurities) in the sludge tank 8 to the sludge reaction tank 18.

The primary precipitation tank 1 and the primary reaction precipitation tank 3 are connected to the pipeline of the sludge drying system 19 through a sludge-discharging pipeline, respectively; and sludge-discharging pipelines of the primary precipitation tank 1 and the reaction precipitation tank 23 were provided with the sludge pump 14. Specifically, the sludge pump 14 on the sludge-discharging pipelines of the primary precipitation tank 1 was configured to transfer the sludge (impurities) in the primary precipitation tank 1 to the sludge tank 8, and the sludge pump 14 on the sludge-discharging pipelines of the primary reaction precipitation tank 3 was configured to transfer the sludge (impurities) in the primary reaction precipitation tank 3 to the sludge tank 8.

The water outlet pipes of the regulating tank 2 and the two-box reaction tank 5 were provided with the booster water pump 12, respectively. Specifically, the booster water pump 12 on the water outlet pipeline of the regulating tank 2 was configured to transport the liquid in the regulating tank 2 to the primary reaction precipitation tank 3, and the booster water pump 12 on the water outlet pipeline of the two-box reaction tank 5 was configured to transfer the liquid in the two-box reaction tank 5 to the quartz sand filter.

In this embodiment, the preliminary precipitation tank 1, the primary reaction precipitation tank 3, the two-box reaction tank 5, the sludge tank 8 and the sludge reaction tank 18 were existing non-standard equipment, and different size and parameters can be designed according to actual needs. The pH meter 27, the first composite coagulant feeding device 9-1, the acid feeding device 10, the base feeding device 11, the screw pump 15, the sludge feeding device 16, and the stacked-screw component 17 were all purchased standard equipment.

### Embodiment 2

As shown in FIG. 1, this embodiment was different from Embodiment 1. When a molybdenum content in the molybdenum-containing sewage was greater than 15 mg/L and less than 30 mg/L, the reaction system 20 included a primary reaction system 21, a secondary reaction system 22 and the two-box reaction tank 5 sequentially connected in series. The molybdenum-containing sewage sequentially flows into the primary precipitation tank 1, the primary reaction system 21, the secondary reaction system 22 and the two-box reaction tank 5 to enter the filtration system 6. The composite coagulant was added into the primary reaction system 21, and a mass concentration of the composite coagulant in the primary reaction system 21 was controlled to be 70-150 mg/L. Hydrochloric acid or sulfuric acid was added into the primary reaction system 21 to adjust pH to 4.5-5. Caustic soda was added into the secondary reaction system 22 to adjust pH to 4.5-5. The composite coagulant was added into the secondary reaction system 22, and a mass concentration of the composite coagulant in the secondary reaction system 22 was controlled to be 30-50 mg/L. Caustic soda was added into the upper tank body 24, and a pH meter was arranged in the lower tank body 25 to measure a pH value in the lower tank body 25. An amount of caustic soda added into the upper tank body 24 was controlled according to the PH value in the lower tank body 25, and a pH value in the two-box reaction tank 5 was controlled to 7-7.5 to make a molybdenum content in the effluent of the two-box reaction tank less than or equal to 1.5 mg/L.

The primary reaction system 21 included a primary reaction precipitation tank 3, a first pH meter 27-1, a composite coagulant feeding device 9 and an acid feeding device 10. The first pH meter 27-1 was arranged on the primary reaction precipitation tank 3, and the pH meter 27 was configured to measure a pH value in the primary reaction precipitation tank 3. The composite coagulant feeding device 9 and the acid feeding device 10 were connected to the primary reaction precipitation tank 3. The composite coagulant was added into the primary reaction precipitation tank 3 of the primary reaction system 21 through the composite coagulant feeding device 9, so that a mass concentration of the composite coagulant in the primary reaction precipitation tank 3 of the primary reaction system 21 was 70-150 mg/L. Hydrochloric acid or sulfuric acid was added into the primary reaction precipitation tank 3 of the primary reaction system 21 through the acid feeding device 10 to adjust a pH value in the primary reaction precipitation tank 3 to 4.5-5. The secondary reaction system 22 included a secondary reaction precipitation tank 4, a second pH meter 27-2, a second composite coagulant feeding device 9-2 and a first caustic soda feeding device 11-1. The reaction precipitation tank 23 consists of the first reaction precipitation tank 3 and the secondary reaction precipitation tank 4. The second pH meter 27-2 was arranged on the secondary reaction precipitation tank 4 to measure a pH value in the secondary reaction precipitation tank 4. The second composite coagulant feeding device 9-2 and the first caustic soda feeding device 11 were connected to the secondary reaction precipitation tank 4. The composite coagulant was added into the secondary reaction precipitation tank 4 of the secondary reaction system 22 through the second composite coagulant feeding device 9-2, so that a mass concentration of the composite coagulant in the secondary reaction precipitation tank 4 of the secondary reaction system 22 was 30-50 mg/L. Caustic soda was added into the secondary reaction precipitation tank 4 of the secondary reaction system 22 through the first caustic soda feeding device 11-1 to adjust the pH value in the secondary reaction precipitation tank 4 to 4.5-5. The bottoms of the primary reaction precipitation tank 3 and the secondary reaction precipitation tank 4 were connected to the pipeline of the sludge drying system 19. The sludge was treated by the sludge drying system 26 to obtain the dry sludge, and the dry sludge was discharged from the sludge drying system 26. The upper tank body 24 of the two-box reaction tank 5 was connected to the caustic soda feeding device 11, and the lower tank body 25 of the two-box reaction tank 5 was provided with a third pH meter 27-3. The third pH meter 27-3 was configured to measures a pH value in the lower tank body 25, and an amount of caustic soda was controlled according to the pH in the lower tank body 25. The pH value in the two-box reaction tank 5 was adjusted to 7-7.5. The two-box reaction tank 5 was connected to the filtration system 6. Specifically, the impurities obtained after the reaction in the primary reaction precipitation tank 3 and the secondary reaction precipitation tank 4 were flowed into the pipeline of the sludge drying system 19, and the supernatant in the primary reaction precipitation tank 3 entered the secondary reaction precipitation tank 4, the two-box reaction tank 5 in turn, and then flowed into the filtration system 6 for filtration.

The sludge-discharging pipelines of the preliminary precipitation tank 1, the primary reaction precipitation tank 3 and the secondary reaction precipitation tank 4 were provided with the sludge pump 14. Specifically, the sludge pump 14 on the sludge-discharging pipeline of the primary reaction precipitation tank 3 was configured to transfer the sludge (impurities) in the primary reaction precipitation tank 3 to the sludge tank 8, and the sludge pump 14 on the sludge-discharging pipeline of the secondary reaction precipitation tank 3 was configured to transfer the sludge (impurities) in the secondary reaction precipitation tank 3 to the sludge tank 8.

In this embodiment, the secondary reaction precipitation tank 3 was existing non-standard equipment, and different size and parameters can be designed according to actual needs.

It should be understood that these embodiments are merely illustrative of the present disclosure, and are not intended to limit the scope of the present disclosure. Any changes, modifications and improvements made by those skilled in the art without departing from the spirit of the present disclosure shall fall within the scope of the present disclosure.

What is claimed is:

1. A method for treating molybdenum-containing sewage in a molybdenum ore area, comprising:
(1) subjecting the molybdenum-containing sewage into a primary precipitation tank followed by standing for 40-60 min to settle impurities in the molybdenum-containing sewage; allowing the impurities to flow into a pipeline of a sludge drying system, and allowing a supernatant in the primary precipitation tank to overflow into a regulating tank;
(2) pumping a liquid in the regulating tank to a reaction precipitation tank of a reaction system through a booster water pump, and adjusting pH of the liquid in the reaction precipitation tank to 4.5-5; adding a composite coagulant into the reaction precipitation tank, wherein the composite coagulant comprises polymeric ferric sulfate and ferrous sulfate; controlling a mass concentration of the composite coagulant in the reaction precipitation tank to be 70-150 mg/L; allowing molybdate ions in the liquid in the reaction precipitation tank to attract the composite coagulant to form a precipitate, and allowing the precipitate to flow into the pipeline of the sludge drying system; allowing a supernatant in the reaction precipitation tank to overflow into a two-box reaction tank; adding caustic soda into the two-box reaction tank to adjust pH of an effluent of the two-box reaction tank to 7.5, and allowing the a supernatant in the two-box reaction tank to enter a filtration system for filtration; and
(3) subjecting the liquid entering the filtration system to filtration to remove impurities such that a molybdenum content in an effluent of the filtration system is less than or equal to 1.5 mg/L.

2. The method of claim 1, wherein when a molybdenum content in the molybdenum-containing sewage is less than or equal to 15 mg/L, the reaction system comprises a primary reaction system and the two-box reaction tank connected with each other; the primary reaction system comprises the reaction precipitation tank; the molybdenum-containing sewage sequentially flows into the primary precipitation tank, the reaction precipitation tank and the two-box reaction tank to enter the filtration system; the composite coagulant is added into the reaction precipitation tank, and the mass concentration of the composite coagulant in the reaction precipitation tank is controlled to be 70-150 mg/L; hydrochloric acid or sulfuric acid is added into the reaction precipitation tank to adjust pH to 4.5-5; the two-box reaction tank comprises an upper tank body and a lower tank body connected with each other; the caustic soda is added into the upper tank body, and a pH meter is arranged in the lower tank body to measure pH value in the lower tank body; an amount of caustic soda added into the upper tank body is controlled according to the pH value in the lower tank body; and pH value in the two-box reaction tank is adjusted to 7-7.5 to make a molybdenum content in the effluent of the two-box reaction tank less than or equal to 1.5 mg/L.

3. The method of claim 1, wherein when a molybdenum content in the molybdenum-containing sewage is greater than 15 mg/L and less than 30 mg/L, the reaction system includes a primary reaction system, a secondary reaction system and the two-box reaction tank sequentially connected in series; the primary reaction system comprises a primary reaction precipitation tank, and the secondary reaction system comprises a secondary reaction precipitation tank; the reaction precipitation tank consist of the primary reaction precipitation tank and the secondary reaction precipitation tank; the molybdenum-containing sewage sequentially flows into the primary precipitation tank, the primary reaction precipitation tank, the secondary reaction precipitation tank and the two-box reaction tank to enter the filtration system; the composite coagulant is added into the primary reaction precipitation tank, and a mass concentration of the composite coagulant in the primary reaction precipitation tank is controlled to be 70-150 mg/L; hydrochloric acid or sulfuric acid is added into the primary reaction precipitation tank to adjust pH to 4.5-5; caustic soda is added into the secondary reaction precipitation tank to adjust pH to 4.5-5; the composite coagulant is added into the secondary reaction precipitation tank, and a mass concentration of the composite coagulant in the secondary reaction precipitation tank is controlled to be 30-50 mg/L; the two-box reaction tank comprises an upper tank body and a lower tank body connected with each other; caustic soda is added into the upper tank body, and a pH meter is arranged in the lower tank body to measure a pH value in the lower tank body; an amount of caustic soda added in the upper tank body is controlled according to the pH value in the lower tank body; and pH in the two-box reaction tank is controlled to 7-7.5 to make a molybdenum content in the effluent of the two-box reaction tank less than or equal to 1.5 mg/L.

4. A treatment system used in the method of claim 1, comprising:
the primary precipitation tank;
the reaction system;
the filtration system; and
the sludge drying system;
wherein the primary precipitation tank, the reaction system and the filtration system are connected in series, and bottoms of the primary precipitation tank and the reaction system are both connected to the sludge drying system; and the molybdenum-containing sewage sequentially flows into the primary precipitation tank, the reaction system and the filtration system to be discharged.

5. The treatment system of claim 4, wherein when a molybdenum content in the molybdenum-containing sewage is less than or equal to 15 mg/L, the reaction system comprises a primary reaction system and the two-box reaction tank connected with each other; the primary reaction system comprises a primary reaction precipitation tank, a first pH meter, a composite coagulant feeding device and an acid feeding device; the first pH meter is arranged on the reaction precipitation tank to measure a pH value in the reaction precipitation tank; the composite coagulant feeding device and the acid feeding device are connected to the reaction precipitation tank, and a bottom of the reaction precipitation tank is connected to a pipeline of the sludge drying system; the two-box reaction tank comprises an upper tank body and a lower tank body connected with each other; the upper tank body is connected to a caustic soda feeding device, and a second pH meter is arranged in the lower tank body to measure a pH value in the lower tank body; and the two-box reaction tank is connected to the filtration system.

6. The treatment system of claim 4, wherein when a molybdenum content in the molybdenum-containing sewage is greater than 15 mg/L and less than 30 mg/L, the reaction system comprises a primary reaction system, a secondary reaction system and the two-box reaction tank sequentially connected in series; the primary reaction system comprises a primary reaction precipitation tank, a first pH meter, a composite coagulant feeding device and an acid feeding device; the first pH meter is arranged on the primary reaction precipitation tank to measure a pH value in the primary reaction precipitation tank; the first composite coagulant feeding device and the acid feeding device are connected to the primary reaction precipitation tank; the secondary reaction system comprises a secondary reaction precipitation tank, a second pH meter, a second composite coagulant feeding device and a first caustic soda feeding device; the reaction precipitation tank consists of the first reaction precipitation tank and the secondary reaction precipitation tank; the second pH meter is arranged on the secondary reaction precipitation tank to measure a pH value in the secondary reaction precipitation tank; the second composite coagulant feeding device and the first caustic soda feeding device are connected to the secondary reaction precipitation tank; bottoms of the primary reaction precipitation tank and the secondary reaction precipitation tank are connected to a pipeline of the sludge drying system; the two-box reaction tank comprises an upper tank body and a lower tank body connected with each other; the upper tank body is connected to a second caustic soda feeding device, and a third pH meter is arranged in the lower tank body to measure a pH value in the lower tank body; and the two-box reaction tank is connected to the filtration system.

7. The treatment system of claim 4, wherein the filtration system is a quartz sand filter; a water inlet end of the quartz sand filter is connected to the two-box reaction tank, and a water outlet end of the quartz sand filter is connected to a water collection tank; and bottoms of the quartz sand filter and the water collection tank are connected to a backwash valve.

8. The treatment system of claim 4, wherein the sludge drying system comprises a sludge tank, a screw pump, a sludge reaction tank, a sludge feeding device and a stacked-screw component; an inlet of the sludge tank is connected to the primary precipitation tank and the reaction precipitation tank of the reaction system through the pipeline of the sludge drying system; an outlet of the sludge tank is connected to the screw pump, and the screw pump is connected to the sludge reaction tank through a pipeline; the sludge feeding device is communicated with the sludge reaction tank, and the sludge reaction tank contains polyacrylamide; and the sludge reaction tank is connected to the stacked-screw component, and the stacked-screw component is configured to discharge dry sludge in the sludge reaction tank.

9. The treatment system of claim 8, wherein the primary precipitation tank and the reaction precipitation tank are connected to the pipeline of the sludge drying system through a sludge-discharging pipeline, respectively; and sludge-discharging pipelines of the primary precipitation tank and the reaction precipitation tank are provided with a sludge pump.

10. The treatment system of claim 4, wherein water outlet pipes of the regulating tank and the two-box reaction tank are provided with the booster water pump, respectively.
